(19) United States
(12) Patent Application Publication
(10) Pub. No.: US 2016/0294272 A1
(43) Pub. Date: Oct. 6, 2016

(54) VIBRATION ELECTRIC GENERATOR

(71) Applicant: Sunlight Eco-Tech Limited, Hong Kong (HK)

(72) Inventor: Shui Hung Mak, Hong Kong (HK)

(21) Appl. No.: 15/084,500

(22) Filed: Mar. 30, 2016

Related U.S. Application Data
(60) Provisional application No. 62/139,799, filed on Mar. 30, 2015.

(51) Int. Cl. H02K 35/02; H02K 11/04

(52) U.S. Cl. CPC H02K 35/02; H02K 11/046

(57) ABSTRACT

A vibration electric generator includes two generator units connected with each other in a lever manner. Each generator unit includes: a moving part configured to move in a linear manner; a permanent magnet attached to the moving part, the permanent magnet being configured to provide a magnetic field; a fixed stator including a plurality of windings; and a cushion made from an impact absorber and installed at each end of the moving part. Due to a vibration motion of a first frequency, the stator is configured to also move in the first frequency. The moving part is configured to move in a second frequency that is different from the first frequency.

### CROSS-REFERENCE TO RELATED APPLICATIONS

This application claims the benefit of U.S. Provisional Patent Application No. 62/139,799, filed Mar. 30, 2015, the entire content of which is hereby incorporated by reference.

### FIELD OF THE PATENT APPLICATION

The present patent application generally relates to generation of electric power and more specifically to a vibration electric generator.

### BACKGROUND

A vibration (electric) generator is designed to convert vibration motions into electric energy through a linear generator. The vibration of a vehicle including a car or a boat usually exhibits vibration. For a car, the uneven surface of road or the load balance on the vehicle, the up and down movements together with the damper in a vehicle is the source of vibration. For a boat, the water wave and the boat propulsion are the sources of vibration. This vibration is usually up and down movement and also with some components in the side movement.

A conventional motion generator (or vibration generator) is based on a rotational electric generator. A mechanical subsystem is used to convert the up and down movement into a rotational motion through a gear and lever arrangement. The requirement of the mechanical connection is relative large and the power loss in the mechanical interfacing will cause substantially loss. Also if the system is to be used in maritime applications such as on boat or on shore to capture the wave energy, the life time of the mechanical subsystem will be a concern as they usually are composed of steel or iron that has a short life time due to rusting and humidity.

### SUMMARY

The present patent application is directed to a vibration electric generator. In one aspect, the vibration electric generator includes two generator units connected with each other in a lever manner. Each generator unit includes: a moving part configured to move in a linear manner; a permanent magnet attached to the moving part, the permanent magnet being configured to provide a magnetic field; a fixed stator including a plurality of windings; and a cushion made from an impact absorber and installed at each end of the moving part. Due to a vibration motion of a first frequency, the stator is configured to also move in the first frequency. The moving part is configured to move in a second frequency that is different from the first frequency.

The generator units may be connected by a lever and a fulcrum. The two generators may be configured to vibrate through the lever and fulcrum connection, while power generated by each generator unit may be in a mechanical anti-phase.

The cushion may be a spring. Pitch of the windings and pitch of permanent magnet may be the same. The vibration electric generator may further include a rectifier connected with the windings. All windings may be connected by a common end thereof and the other ends of the windings may be connected to the rectifier. The vibration electric generator may further include a DC-DC converter connected with the rectifier and an energy storage connected with the DC-DC converter. The DC-DC converter may be a Buck, Boost or Buck-boost DC-DC converter, while the energy storage may be a battery set, capacitor or super-capacitor or a combination thereof.

Two windings may be connected at one end thereof, while the other ends of the two windings may be connected through a third winding.

In another aspect, the vibration electric generator includes: a generator unit, the generator unit including: a moving part configured to move in a linear manner; a permanent magnet attached to the moving part, the permanent magnet being configured to provide a magnetic field; and a fixed stator including a plurality of windings; a rectifier connected with the windings; a DC-DC converter connected with the rectifier; an energy storage connected with the DC-DC converter; and a cushion made from an impact absorber and installed at each end of the moving part. Due to a vibration motion of a first frequency, the stator is configured to also move in the first frequency. The moving part is configured to move in a second frequency that is different from the first frequency. Pitch of the windings and pitch of permanent magnet are the same.

All windings may be connected by a common end thereof and the other ends of the windings may be connected to the rectifier. Two windings may be connected at one end thereof, while the other ends of the two windings may be connected through a third winding.

In yet another aspect, the vibration electric generator includes: a moving part configured to move in a linear manner; a permanent magnet attached to the moving part, the permanent magnet being configured to provide a magnetic field; a fixed stator including a plurality of windings; and a cushion made from an impact absorber and installed at each end of the moving part. Due to a vibration motion of a first frequency, the stator is configured to also move in the first frequency. The moving part is configured to move in a second frequency that is different from the first frequency.

The cushion may be a spring. Pitch of the windings and pitch of permanent magnet may be the same. The vibration electric generator may further include a rectifier connected with the windings. All windings may be connected by a common end thereof and the other ends of the windings may be connected to the rectifier.

The vibration electric generator may further include a DC-DC converter connected with the rectifier and an energy storage connected with the DC-DC converter. Two windings may be connected at one end thereof, while the other ends of the two windings may be connected through a third winding.

### BRIEF DESCRIPTIONS OF THE DRAWINGS

FIG. 1 is a cross-sectional view of a vibration electric generator in accordance with an embodiment of the present patent application.

FIG. 2 is a cross-sectional view of a vibration electric generator in accordance with another embodiment of the present patent application.

FIG. 3 shows how the windings and the permanent magnet are arranged in a vibration electric generator in accordance with an embodiment of the present patent application.

FIG. 4 is a cross-sectional view of a vibration electric generator in accordance with yet another embodiment of the present patent application.

FIG. 5 illustrates that the winding output is electrically rectified.

FIG. 6 shows how the windings are connected in a vibration electric generator in accordance with an embodiment of the present patent application.

FIG. 7 shows how the windings are connected in a vibration electric generator in accordance with another embodiment of the present patent application.

FIG. 8 illustrates a vibration electric generator in accordance with an embodiment of the present patent application being used in a boat.

### DETAILED DESCRIPTION

Reference will now be made in detail to a preferred embodiment of the vibration electric generator disclosed in the present patent application, examples of which are also provided in the following description. Exemplary embodiments of the vibration electric generator disclosed in the present patent application are described in detail, although it will be apparent to those skilled in the relevant art that some features that are not particularly important to an understanding of the vibration electric generator may not be shown for the sake of clarity.

Furthermore, it should be understood that the vibration electric generator disclosed in the present patent application is not limited to the precise embodiments described below and that various changes and modifications thereof may be effected by one skilled in the art without departing from the spirit or scope of the protection. For example, elements and/or features of different illustrative embodiments may be combined with each other and/or substituted for each other within the scope of this disclosure.

In the following embodiments, linear actuator based on a linear motor unit can be configured into a generator. For motion that is of linear type, a linear motion unit based on electromagnetic device can be used for the power generation. The vibration generator is configured to capture the linear motion from a holder or container and convert motion energy that is captured from such linear motion to electric energy.

According to an embodiment, the present patent application provides a vibration electric generator that is suitable for use with a boat or a car. The vibration electric generator includes: a linear electromagnetic power generator which includes a coil and a permanent magnet; a supporting mechanical interface configured to allow the generator to absorb vibration energy; a cushion at both ends of a mover of the linear electromagnetic power generator; and electronic driver configured to convert AC voltage from the generator to an energy storage devices or any DC output.

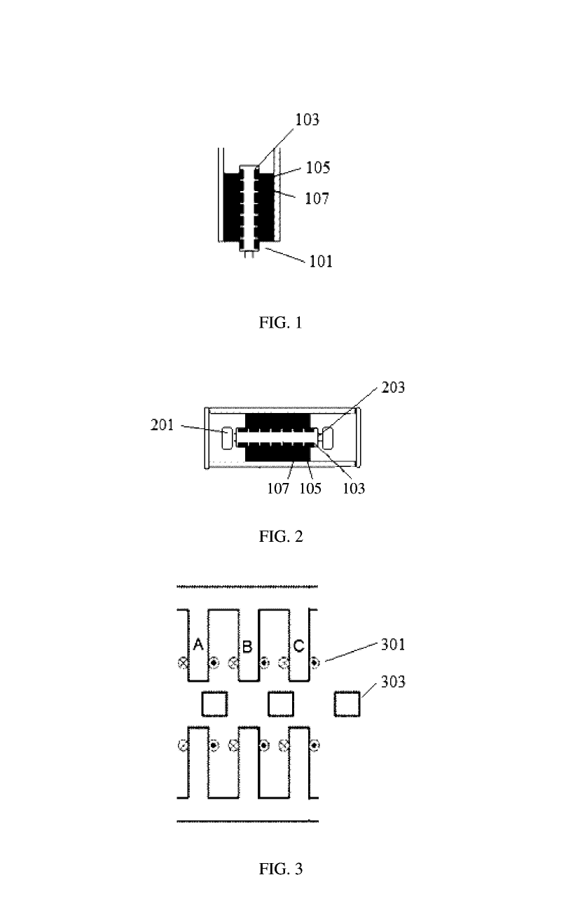

FIG. 1 is a cross-sectional view of a vibration electric generator in accordance with an embodiment of the present patent application. Referring to FIG. 1, the vibration electric generator includes a moving part 101; a permanent magnet 103 attached to the moving part 101, the permanent magnet 103 being configured to provide a magnetic field; and a fixed stator 105 including a plurality of windings 107. An electric output is derived from the windings 107. The number of windings depends on the electromagnetic design. FIG. 1 shows only 3 sets of windings, but the number of windings can be varied in a way that depends on the amplitude of vibration. The moving part 101 is a mover configured to move in a linear manner. During a vibration, the mover 101 is configured to move due to the vibration motion. The stator 105 also moves in the same frequency as the vibration. However, the mover 101 will move at a different frequency, phase angle or amplitude because it is not a fixed component and its inertia makes it move differently from the stator 105.

The basic equation of the power generation is based on the change of the magnetic flux by the winding 107 intersected by the flux produced by the permanent magnet 103. i.e.

V=NdΦ/dt (1)

where N is the number of turns of the windings 107. Φ is the magnetic flux produced by the permanent magnet 103. d/dt is the ratio of change which is the vibration frequency.

The generator should have a number of windings 107. Therefore each winding will have the power generation effect. The outputs are added together in an electrical manner.

In order to enhance the vibration energy capture, a cushion 201 is installed at each end of the mover 203 as shown in FIG. 2. FIG. 2 is drawn deliberately in a horizontal orientation because the vibration may also be in horizontal orientation and in this case the vibration generator should be placed horizontally. The cushion 201 may be made from an impact absorber including plastic and it can be a spring.

Using a spring as the absorber has a number of advantages. It can provide an electromagnet with mechanical vibration and therefore the vibration can be sustained for a period of time even after the vibration finishes. It can also make the incoming vibration energy oscillate with the cushion (spring) and mover and therefore certain energy storage can be stored in the cushion. The vibration energy can be released in a gentle manner through winding output as an electromagnetic power generator.

FIG. 2 illustrates an application using a single unit for power generation. FIG. 3 shows how the windings 301 and the permanent magnet 303 are arranged in a vibration electric generator in accordance with an embodiment of the present patent application. The pitch of the windings 301 and the pitch of permanent magnet 303 should be the same. However, they can also be different in order to make different power output waveforms.

FIG. 4 is a cross-sectional view of a vibration electric generator in accordance with yet another embodiment of the present patent application. Referring to FIG. 4, the vibration electric generator includes two generator units 401 and 403 connected with each other in a lever manner. More specifically, the generator units 401 and 403 are connected by a lever 405 and a fulcrum 407. During a vibration, the two vertical generator units 401 and 403 also vibrate through the lever and fulcrum connection. The power generated by each generator unit is in a mechanical anti-phase. Referring to FIG. 4, the vibration electric generator is installed to a vehicle body 409 through a support structure 411.

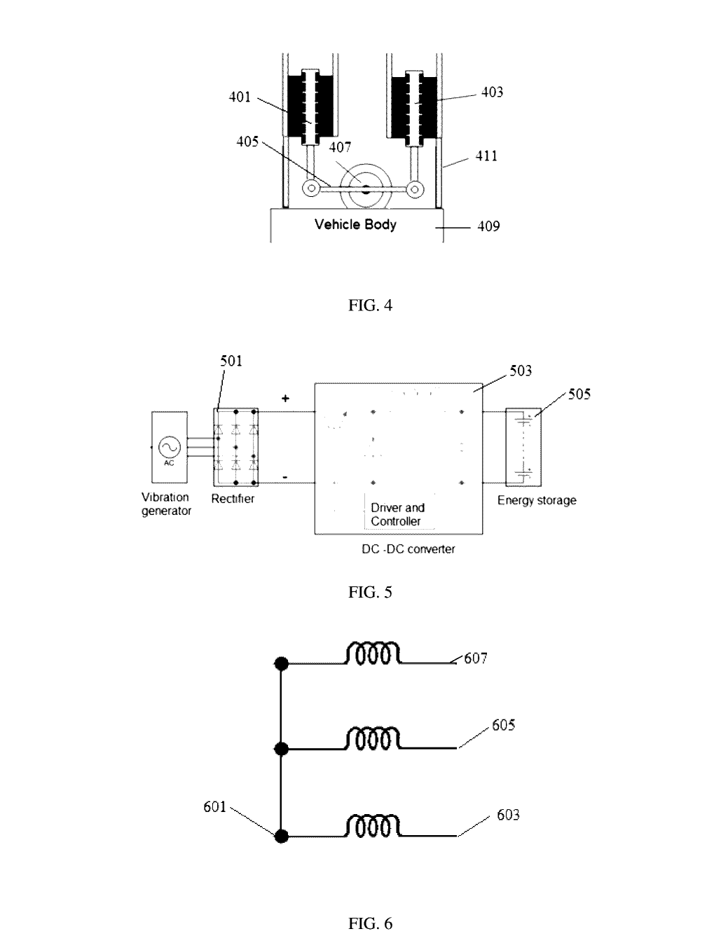

To connect the electrical output to an electrical load, the winding output should be rectified electrically by a rectifier 501 connected with the windings as shown in FIG. 5. The output from the generator has a number of electrical connections.

FIG. 6 shows how the windings are connected in a vibration electric generator in accordance with an embodiment of the present patent application. Referring to FIG. 6, 3 windings in the generator are connected in a star connection. All windings are connected by a common end 601 thereof and the other ends (603, 605 and 607) of the windings are connected to the rectifier. When more windings exist, the number of the rectifier legs will also be increased. The number of the rectifier legs in FIG. 6 is three. Two diodes are needed to form one rectifier leg.

The rectifier rectifies the AC voltage produced by the generator into DC as indicated by + and − in the diagram of FIG. 5. The DC voltage can be added with a capacitor for filtering between connections to the DC-DC converter 503. The DC-DC converter 503 can be selected from various topologies such as Buck, Boost or Buck-boost. The circuit 503 shown in FIG. 5 is a Buck converter. The output of the DC-DC converter 503 is connected to an energy storage 505. The energy storage 505 is a battery set, capacitor or super-capacitor or a combination thereof. The energy storage 505 is made up by a number of energy storage devices in series or parallel or series and parallel. The total voltage is the sum of those energy storage devices connected in series.

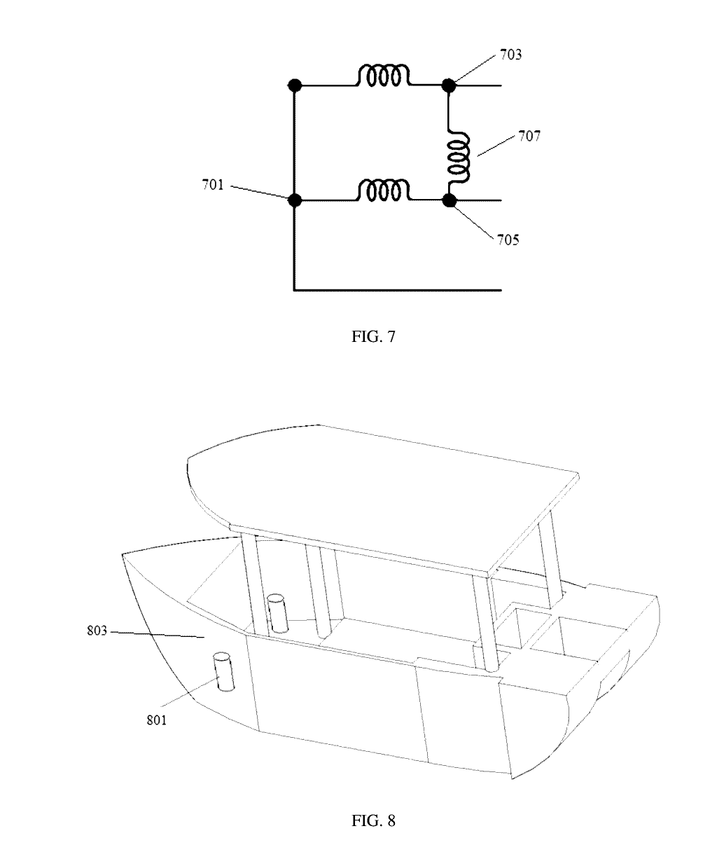

FIG. 7 shows how the windings are connected in a vibration electric generator in accordance with another embodiment of the present patent application. Referring to FIG. 7, the windings are connected in a delta manner. More specifically, two windings are connected at one end 701 thereof, while the other ends of the two windings (703 and 705) are connected through a third winding 707. The output can be connected to the rectifier as shown in FIG. 5.

The electric vibration generator provided by the above embodiments can be used in a boat or a car. FIG. 8 shows the application in a boat. The vibration generators 801 are installed in the boat compartment 803. The best position depends on the up and down movement of the vehicle and the users can select the location that has higher amplitude of vibration due to the water or environment condition.

The vibration electric generator provided by the above embodiments is suitable for use with a vehicle. According to an embodiment, the vibration electric generator includes a linear electromagnetic generator, a cushion, a rectifier, a DC-DC converter, an energy storage device. The linear electromagnetic generator includes a mover, a stator, of which the mover is a linear bar or rectangle, or cylindrical devices with permanent magnet attached to it to provide magnetic flux. The stator includes windings. The windings are copper or other conductor wires with electrical isolation coating. The number of winding turns depends on the voltage demand and is controlled by Faraday's Law as seen in equation (1). The number of windings can be one or more. For more than 2 windings, the windings can be star connected or delta connected. The output from each winding terminal can be connected to the rectifier.

The number of permanent magnet devices has no limit. It depends on the vibration amplitude so that the amplitude will cover the length of the permanent magnets which are separated by a distance which allows the mutual flux between two adjacent permanent magnets to be small.

The cushion is configured to provide a protection and absorption of vibration. The cushion is a damper, and also can be a spring to provide a sustainable vibration between the electromagnetic vibration and the mechanical vibration through the cushion or spring.

The rectifier's input is configured to accept the winding terminal connection and to rectify the AC power signals from the generator. The rectifier legs each formed by 2 diodes are configured to rectifier each of the terminal voltage to become positive or negative output voltages.

The energy storage is a connection of battery cells, super capacitors or capacitor. It can be a combination by some of them in series or parallel or both. The pitch of the permanent magnet and the pitch of the windings can be equal as a preferred condition. It can also be different in order to modify the waveforms generated. The DC-DC converter is to convert the voltage from the output of the rectifier to the output which is a DC energy storage device. The converter is to match the voltage from the rectifier to the DC voltage which is usually controlled by duty ratio of the transistor. A control loop is configured to regulate the charging to the energy storage devices.

While the present patent application has been shown and described with particular references to a number of embodiments thereof, it should be noted that various other changes or modifications may be made without departing from the scope of the present invention.

What is claimed is:

1. A vibration electric generator comprising two generator units connected with each other in a lever manner, each generator unit comprising:
a moving part configured to move in a linear manner;
a permanent magnet attached to the moving part, the permanent magnet being configured to provide a magnetic field;
a fixed stator comprising a plurality of windings; and
a cushion made from an impact absorber and installed at each end of the moving part;
wherein:
due to a vibration motion of a first frequency, the stator is configured to also move in the first frequency; and
the moving part is configured to move in a second frequency that is different from the first frequency.

2. The vibration electric generator of claim 1, wherein the generator units are connected by a lever and a fulcrum.

3. The vibration electric generator of claim 2, wherein the two generators are configured to vibrate through the lever and fulcrum connection, while power generated by each generator unit is in a mechanical anti-phase.

4. The vibration electric generator of claim 1, wherein the cushion is a spring.

5. The vibration electric generator of claim 1, wherein pitch of the windings and pitch of permanent magnet are same.

6. The vibration electric generator of claim 1 further comprising a rectifier connected with the windings.

7. The vibration electric generator of claim 6, wherein all windings are connected by a common end thereof and the other ends of the windings are connected to the rectifier.

8. The vibration electric generator of claim 6 further comprising a DC-DC converter connected with the rectifier and an energy storage connected with the DC-DC converter.

9. The vibration electric generator of claim 8, wherein the DC-DC converter is a Buck, Boost or Buck-boost DC-DC converter, while the energy storage is a battery set, capacitor or super-capacitor or a combination thereof.

10. The vibration electric generator of claim 6, wherein two windings are connected at one end thereof, while the other ends of the two windings are connected through a third winding.

11. A vibration electric generator comprising:
a generator unit, the generator unit comprising:
a moving part configured to move in a linear manner;
a permanent magnet attached to the moving part, the permanent magnet being configured to provide a magnetic field; and
a fixed stator comprising a plurality of windings;
a rectifier connected with the windings;
a DC-DC converter connected with the rectifier;
an energy storage connected with the DC-DC converter; and
a cushion made from an impact absorber and installed at each end of the moving part;
wherein:
due to a vibration motion of a first frequency, the stator is configured to also move in the first frequency;
the moving part is configured to move in a second frequency that is different from the first frequency; and
pitch of the windings and pitch of permanent magnet are same.

12. The vibration electric generator of claim 11, wherein all windings are connected by a common end thereof and the other ends of the windings are connected to the rectifier.

13. The vibration electric generator of claim 11, wherein two windings are connected at one end thereof, while the other ends of the two windings are connected through a third winding.

14. A vibration electric generator comprising:
a moving part configured to move in a linear manner;
a permanent magnet attached to the moving part, the permanent magnet being configured to provide a magnetic field;
a fixed stator comprising a plurality of windings; and
a cushion made from an impact absorber and installed at each end of the moving part;
wherein:
due to a vibration motion of a first frequency, the stator is configured to also move in the first frequency; and
the moving part is configured to move in a second frequency that is different from the first frequency.

15. The vibration electric generator of claim 14, wherein the cushion is a spring.

16. The vibration electric generator of claim 14, wherein pitch of the windings and pitch of permanent magnet are same.

17. The vibration electric generator of claim 14 further comprising a rectifier connected with the windings.

18. The vibration electric generator of claim 17, wherein all windings are connected by a common end thereof and the other ends of the windings are connected to the rectifier.

19. The vibration electric generator of claim 17 further comprising a DC-DC converter connected with the rectifier and an energy storage connected with the DC-DC converter.

20. The vibration electric generator of claim 17, wherein two windings are connected at one end thereof, while the other ends of the two windings are connected through a third winding.
